(19) United States
(12) Patent Application Publication
(10) Pub. No.: US 2017/0154348 A1
(43) Pub. Date: Jun. 1, 2017

(54) DYNAMIC PRICING SYSTEMS AND RELATED METHODS

(71) Applicant: XEROX CORPORATION, Norwalk, CT (US)

(72) Inventors: Arpita Biswas, Kolkata (IN); Koyel Mukherjee, Bangalore (IN); Pallavi Manohar, Thane (IN); Partha Dutta, Bangalore (IN)

(21) Appl. No.: 14/953,499

(22) Filed: Nov. 30, 2015

(51) Int. Cl. G06Q 30/02; G06Q 50/30

(52) U.S. Cl. CPC G06Q 30/0206; G06Q 50/30; G06Q 30/0222

(57) ABSTRACT

Embodiments of a dynamic pricing system for determining an optimal commission rate based on a service request being served are disclosed. The dynamic pricing system comprises at least one service device that can communicate with a request device, wherein the at least one service device provides a response for a service request; and a dynamic pricing device interfacing with the at least one service device, wherein the dynamic pricing device determines an optimal commission rate corresponding to a request type for the at least one service device, wherein the optimal commission rate maximizes revenue from the service request.

### TECHNICAL FIELD

Some of the disclosed embodiments relate to information systems, and more particularly, to dynamic pricing systems and related methods.

### BACKGROUND

Popularity of cab services has risen significantly over time for point-to-point transportation due to changing lifestyle and limited choices of public transit. Typically, these services are provided based on either fixed or dynamic pricing models through aggregation of multiple cab operators or individual drivers by cab service providers such as Uber, Lyft, Ola, etc.

Under the fixed pricing model, the cab services are provided to customers at fixed prices, which often under-incentivize cab drivers, especially during adverse operating conditions such as those related to road surface conditions (e.g., potholes, speed bumps, road maintenance work, etc.), weather conditions (e.g., rainfall, snowfall, etc.), natural phenomena (e.g., floods, fallen trees, etc.), human activities (e.g., crowd protests, traffic jams, road accidents, etc.), and so on, which can increase the operating cost for the drivers. This may discourage cab drivers to service particular routes or at specific time of the day, and may therefore degrade service reliability.

Under the dynamic pricing model, the cab services are provided to the customers at variable prices based on different operating conditions. Conventional dynamic pricing models adjust prices for cab services based on real-time conditions (e.g., number of service requests, type of service vehicle, etc.) at a particular time. The adjusted prices can vary up to orders of magnitude beyond a standard fare, and during certain high-demand or high-operating cost events the adjusted prices can often surge beyond customer-anticipated prices. This leads to inconsistent customer experience due to loss of clarity and guarantee about cost-effective fares, thereby resulting in customer dissatisfaction that may negatively affect customer loyalty.

Therefore, there exists a need for a dynamic pricing system for cab services that manages service reliability while offering consistent service prices to customers.

### SUMMARY

One embodiment of the present disclosure includes a dynamic pricing system for determining an optimal commission rate based on a service request being served. The dynamic pricing system comprises at least one service device that can communicate with a request device, wherein the at least one service device provides a response for a service request; and a dynamic pricing device interfacing with the at least one service device, wherein the dynamic pricing device determines an optimal commission rate corresponding to a request type for the at least one service device, wherein the optimal commission rate maximizes revenue from the service request.

Another embodiment of the present disclosure includes a dynamic pricing device for determining an optimal commission rate based on a service request being served. The dynamic pricing device comprises a commission rate computation (CRC) module and a matching module. The CRC module is configured to receive a service request that has a request type based on at least one of a request source, request destination, or a request time; and estimate a commission rate for serving the service request based on the request type. The matching module is in communication with the CRC module, wherein the matching module is configured to match the service request to one or more service devices available for service within a predefined service vicinity of the request source, wherein the one or more service devices receive the estimated commission rate; and receive a response from the one or more service devices for the service request based on the estimated commission rate. The CRC module is further configured to update the estimated commission rate based on the received response to determine an optimal commission rate for the request type, wherein the optimal commission rate maximizes revenue earned from the service request.

Yet another embodiment of the present disclosure includes a computer-implemented method for determining an optimal commission rate based on a service request being served. The method comprises receiving, by a commission rate computation (CRC) module, a service request that has a request type based on at least one of a request source, request destination, or a request time; estimating, by the CRC module, a commission rate for serving the service request based on the request type; matching, by a matching module in communication with the CRC module, the service request to one or more service devices available for service within a predefined service vicinity of the request source, wherein the one or more service devices receive the estimated commission rate; receiving, by the matching module, a response from the one or more service devices for the service request based on the estimated commission rate; and updating, by the CRC module, the estimated commission rate based on the received response to determine an optimal commission rate for the request type, wherein the optimal commission rate maximizes revenue earned from the service request.

Still another embodiment of the present disclosure includes a non-transitory computer-readable medium comprising computer-executable instructions for determining an optimal commission rate based on a service request being served. The non-transitory computer-readable medium comprises instructions for receiving, by a commission rate computation (CRC) module, a service request that has a request type based on at least one of a request source, request destination, or a request time; estimating, by the CRC module, a commission rate for serving the service request based on the request type; matching, by a matching module in communication with the CRC module, the service request to one or more service devices available for service within a predefined service vicinity of the request source, wherein the one or more service devices receive the estimated commission rate; receiving, by the matching module, a response from the one or more service devices for the service request based on the estimated commission rate; and updating, by the CRC module, the estimated commission rate based on the received response to determine an optimal commission rate for the request type, wherein the optimal commission rate maximizes the revenue earned based on the service request being served.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a schematic that illustrates a system implementing an exemplary dynamic pricing device, according to an embodiment of the present disclosure.

FIG. 2 is a schematic illustrating the dynamic pricing device of FIG. 1, according to an embodiment of the present disclosure.

FIG. 3 is a schematic that illustrates an exemplary operation of the dynamic pricing device of FIG. 1, according to an embodiment of the present disclosure.

FIG. 4 is a flowchart illustrating exemplary method steps for determining an optimal commission rate, according to an embodiment of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

### NON-LIMITING DEFINITIONS

A “request device” is used in the present disclosure in the context of its broadest definition. The request device may refer to a networked computing device configured to at least one of (1) store, manage, or process data or documents; (2) establish a communication channel or environment, and (3) request services from other devices connected to a network. Various examples of the request device include a desktop PC, a personal digital assistant (PDA), a server, a mainframe computer, a mobile computing device (e.g., mobile phones, laptops, etc.), an Internet appliance, etc.

A “service device” is used in the present disclosure in the context of its broadest definition. The service device may refer to a networked computing device configured to at least one of (1) store, manage, or process data or documents, (2) establish a communication channel or environment, and (3) deliver services or assist other networked devices to deliver services to the request device. Various examples of the service device include a desktop PC, a personal digital assistant (PDA), a server, a mainframe computer, a mobile computing device (e.g., mobile phones, laptops, etc.), an Internet appliance, etc.

A “service operator” is used in the present disclosure in the context of its broadest definition. The service operator may refer to an entity, such as a cab driver, that has custody of resources (e.g., instruments, vehicles, manpower, service devices, service or product licenses, etc.) for delivering services to a customer. In some embodiments, the service operator may independently or simultaneously behave as a service provider.

A “service provider” is used in the present disclosure in the context of its broadest definition. The service provider may refer to an entity that provides services to a customer via an aggregated set of one or more service operators. In some embodiments, the service provider may function as the service operator.

A “request source” is used in the present disclosure in the context of its broadest definition. The service source may refer to a geographical location or a service zone from where a request for service originates.

A “request destination” is used in the present disclosure in the context of its broadest definition. The service destination may refer to a geographical location or a service zone for which a service is requested.

A “request time” is used in the present disclosure in the context of its broadest definition. The service time may refer to a time at which service is requested.

“Service vicinity” is used in the present disclosure in the context of its broadest definition. The service vicinity may refer to a geographical location within a predefined radius, for example, 10 Kilometers, of an imaginary circle on a map having the request source at the center of such circle.

A “commission rate” is used in the present disclosure in the context of its broadest definition. The commission rate may refer to a portion of revenue or profit, which the service provider charges the service operator that has served a request for service.

A “digital wallet” is used in the present disclosure in the context of its broadest definition. The digital wallet may refer to a repository of virtual money having value equivalent to real money, thereby allowing an individual to make electronic financial transactions.

“Optimal commission rate” is used in the present disclosure in the context of its broadest definition. The optimal commission rate may refer to a minimal commission rate within a predefined range, such that the minimal commission rate maximizes the revenue or profit of the service provider or the service operator for a predetermined type of service request.

### Overview

Embodiments are disclosed that can provide a dynamic pricing system for determining commission rates offered to service operators and service providers. In one embodiment, a dynamic pricing system for determining commission rates can be offered to taxi services for different types of requests or rides from customers. The embodiment for a dynamic pricing system can also include beneficial discounts offered to customers of the taxi service. The commission rates can be dynamically determined based on one or more factors that include source and destination of service location, route requested (heavy traffic or light traffic, road conditions, etc.), type of service (class of vehicle, etc.), start and end times of the service request (e.g., peak hours or non-peak hours) and the profiles of the drivers. The type of request can be determined by origin, destination, and time of request. The optimal commission rates are estimated for taxi drivers, in a limited number of iterations, using exploration-exploitation framework. The model is a semi-batched one, where service requests are allowed to accumulate for every time epoch (e.g., typically, less than 1 min.) and thereafter matched with available cabs, limousines, etc., in real time. This can be accomplished using the knowledge of current estimates of acceptable commission rates to the drivers as learned by the dynamic pricing system. When the responses of drivers are known, the estimates are updated by matching the requests to the driver's response. Behavior of each driver is assumed to be consistent, and only those drivers are considered whose cabs are available to service a request within a predetermined radius of each request. In some embodiments customer discounts can be provided using prepaid plans using an electronic wallet to reward loyalty. These discounts are provided to the customer in advance to implement transparency and encourage customer loyalty to the service provider.

### Exemplary Embodiments

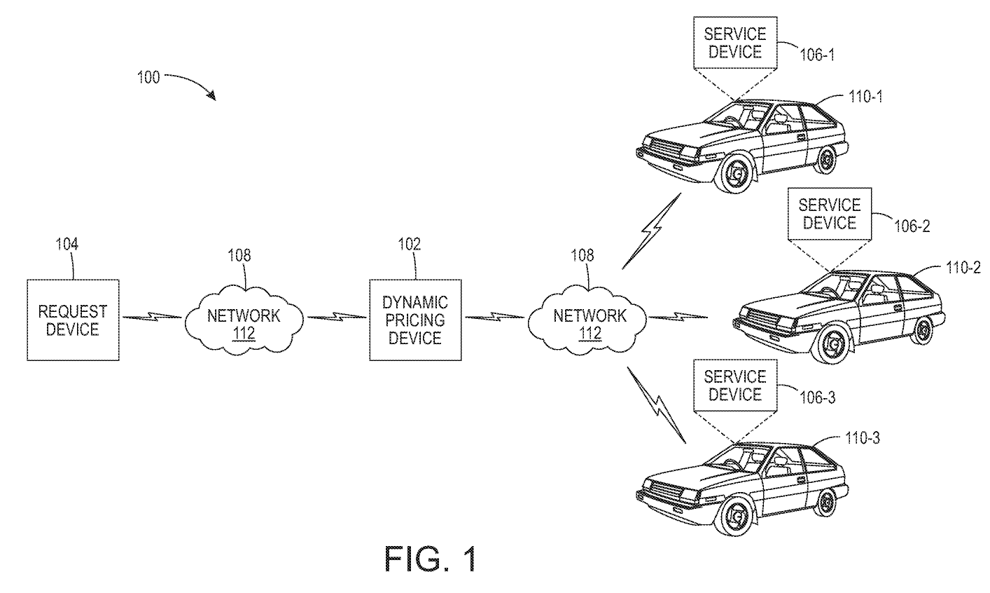

FIG. 1 is a schematic that illustrates a system implementing an exemplary dynamic pricing device 102, according to an embodiment of the present disclosure. Some embodiments are disclosed in the context of dynamic pricing models for providing cab services such as, but not limited to, taxi services, limousine services, shared ride services, bus services, etc. However, other embodiments are intended to include or otherwise cover various on-demand services (e.g., housekeeping services, utility services such as Internet services and plumbing services, installation services, etc.), location-based services (e.g., tourist guide services, food services, mobile services, etc.), and transport services (e.g., delivery services, moving services, courier services, etc.). The disclosed embodiments may be implemented to manage pricing for services provided through aggregation of unassociated service operators.

Embodiments include a dynamic pricing system 100 that includes a dynamic pricing device 102 in communication with one or more request devices such as a request device 104 and service devices 106 such as service devices 106-1, 106-2, 106-3 (collectively, service devices 106) over a network 108. The network 108 may include any software, hardware, or computer applications that can provide a medium to exchange signals or data in any of the formats known in the art, related art, or developed later. Communication network 108 may include, but is not limited to, social media platforms implemented as a website, a unified communication application, or a standalone application. Examples of the social media platforms may include, but are not limited to, Twitter™, Facebook™, Skype™, Microsoft Lync™, Cisco Webex™, and Google Hangouts™. Further, the network 108 may include, for example, one or more of the Internet, Wide Area Networks (WANs), Local Area Networks (LANs), analog or digital wired and wireless telephone Networks (e.g., a PSTN, Integrated Services Digital Network (ISDN), a cellular network, and Digital Subscriber Line (xDSL), Wi-Fi, radio, television, cable, satellite, and/or any other delivery or tunneling mechanism for carrying data. Network 108 may include multiple networks or sub-networks, each of which may include, for example, a wired or wireless data pathway. The network 108 may include a circuit-switched voice network, a packet-switched data network, or any other network able to carry electronic communications. For example, the network 108 may include networks based on the Internet protocol (IP) or asynchronous transfer mode (ATM), and may support voice using, for example, VoIP, Voice-over-ATM, or other comparable protocols used for voice, video, and data communications.

The request device 104 may interact with the service devices 106 via the dynamic pricing device 102. Such interaction may be performed using command signals, text messages, audio interaction data (e.g., voice calls, audio messages, pre-recorded audio messages, etc.), video interaction data (e.g., video calls, video messages, pre-recorded video messages, etc.), or in any combination thereof. Each of the request device 104 and the service devices 106 may include calling devices (e.g., a telephone, a mobile phone, an Internet phone, etc.), texting devices (e.g., a pager), or computing devices including a desktop PC, a personal digital assistant (PDA), a server, a mainframe computer, a mobile computing device (e.g., mobile phones, laptops, etc.), an Internet appliance, etc. As illustrated, the service devices 106 may be operationally associated with, installed on, or integrated with vehicles such as cabs 110-1, 110-2, and 110-3.

In some embodiments, the dynamic pricing system may represent or include a service marketplace referring to a computing environment that includes a group of interconnected computing devices, for example, service devices 106, which communicate with each other over the network 108. These computing devices may include a variety of known, related art, or later developed devices, including those mentioned above. Such service marketplace may include the dynamic pricing device 102 configured to store, manage, or process instructions or data, and establish communication between the request device 104 and the service devices 106 based on a predefined service level agreement (SLA) such as data uplink and downlink bandwidth, discounts for customers, commission rates for service operators such as cab drivers, convenience or handling fee per service execution or software application/communication platform access, service duration, etc.

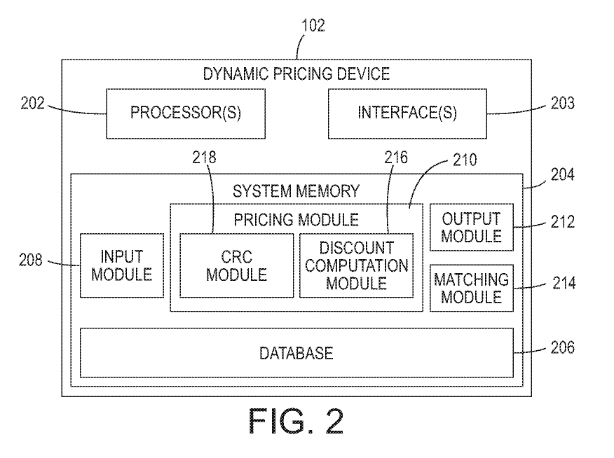

The dynamic pricing device 102 may be configured to at least one of (1) communicate synchronously or asynchronously with one or more software applications, databases, storage devices, or appliances operating via same or different communication protocols, formats, database schemas (see FIG. 2), platforms or any combination thereof, to receive instructions or data; (2) collect, record, analyze, filter, index, and manipulate data including service request data (e.g., request location, requested destination, time of request, etc.) and service condition data (e.g., service radius with reference to a request device 104, available cabs within the service vicinity, etc.); and (3) provide, execute, communicate, formulate, and train one or more mathematical models for tasks that (a) compute optimal commission rates for service operators that maximizes revenue or profit of the service provider; (b) instrument discounts for customers through a digital wallet; (c) update offered commission rates for service operators based on responses of the service operators for the offered commission rates for different types of service requests; and (d) generate indications (e.g., customizable visual representations) for offered commission rates for service operators and service operator details (e.g., accepted commission rate, servicing request type, cab driver name, cab license number, etc.).

The dynamic pricing device 102 may represent any of a wide variety of devices capable of providing dynamic pricing models as a service to networked devices. The dynamic pricing device 102 may be implemented as a standalone and dedicated device including hardware and installed software, where the hardware is closely matched to the requirements and/or functionality of the software. Alternatively, the dynamic pricing device 102 may be implemented as a software application or a device driver. In some other embodiments, the dynamic pricing device 102 may be configured to expose its computing environment or operating code to a user. The dynamic pricing device 102 of some embodiments may, however, include software, firmware, or other resources that support remote administration and/or maintenance of the dynamic pricing device 102.

In further embodiments, the dynamic pricing device 102 either in communication with any of the networked devices such as a mobile phone, or independently, may have video, voice, and data communication capabilities (e.g., unified communication capabilities) by being coupled to or including, additional imaging devices (e.g., printers, cameras, scanners, medical imaging systems, etc.), various audio devices (e.g., microphones, music players, recorders, audio input devices, speakers, audio output devices, telephones, speaker telephones, etc.), various video devices (e.g., monitors, projectors, displays, televisions, video output devices, video input devices, camcorders, etc.), or any other type of hardware, in any combination thereof. In some embodiments, the dynamic pricing device 102 may comprise or implement one or more real time protocols and non-real time protocols known in the art, related art, or developed later to facilitate data transfer among the request device 104, the service devices 106, the dynamic pricing device 102, and any other networked device.

In some embodiments, the dynamic pricing device 102 may be configured to convert communications, which may include instructions, queries, data, etc., from the request device 104 into appropriate formats to make these communications compatible with the service devices 106, and vice versa. Consequently, the dynamic pricing device 102 may allow implementation of the request device 104 using different technologies or by different organizations, for example, a third-party vendor, managing the request device 104 or associated services using a proprietary technology.

In another embodiment, the request device 104 may be configured to interact with the service devices 106 via a server (not shown) over the network 108. The server may be installed, integrated, or operatively associated with the dynamic pricing device 102. The server may be implemented as any of a variety of computing devices including, for example, a general purpose computing device, multiple networked servers (arranged in clusters or as a server farm), a mainframe, or so forth.

In further embodiments (not shown), the request device 104 or the services may be installed or integrated with the dynamic pricing device 102. The dynamic pricing device 102 may be configured to interface between the request device 104 and the service devices 106. Each of such request device 104 and the service devices 106 may be associated with a variety of input and output devices known in the art, related art, or developed later.

In some embodiments, the dynamic pricing device 102 may be installed on or integrated with any network appliance (not shown) configured to establish the network 108, 204 between the request device 104 and the service devices 106. At least one of the dynamic pricing device 102 and the network appliance may be capable of operating as or providing an interface to assist exchange of software instructions and data among the request device 104, the service devices 106, and the dynamic pricing device 102. In some embodiments, the network appliance may be preconfigured or dynamically configured to include the dynamic pricing device 102 integrated with other devices. For example, the dynamic pricing device 102 may be integrated with a server or any other device (not shown) connected to the network 108. The server may include a module (not shown), which may enable the server for being introduced to the network appliance, thereby enabling the network appliance to invoke the dynamic pricing device 102 as a service. Examples of the network appliance include, but are not limited to, a DSL modem, a wireless access point, a router, a base station, and a gateway having a predetermined computing power sufficient for implementing the dynamic pricing device 102.

FIG. 2 is a schematic illustrating the dynamic pricing device of FIG. 1, according to an embodiment of the present disclosure. As illustrated in FIG. 2, the dynamic pricing device 102 may be implemented by way of a single device (e.g., a computing device, a processor or an electronic storage device) or a combination of multiple devices that are operatively connected or networked together. The dynamic pricing device 102 may be implemented in hardware or a suitable combination of hardware and software. In some embodiments, the dynamic pricing device 102 may be a hardware device including processor(s) 202 executing machine readable program instructions for analyzing instructions or data received from the request device 104 and the service devices 106. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processor(s). The processor(s) 202 may include, for example, microprocessors, microcomputers, microcontrollers, digital signal processors, central processing units, state machines, logic circuits, and/or any devices that manipulate signals based on operational instructions. Among other capabilities, the processor(s) 202 may be configured to fetch and execute computer readable instructions in a memory 204 associated with the dynamic pricing device 102 for performing tasks such as signal coding, data processing input/output processing, power control, and/or other functions.

In some embodiments, the dynamic pricing device 102 may include, in whole or in part, a software application working alone or in conjunction with one or more hardware resources. Such software applications may be executed by the processor(s) 202 on different hardware platforms or emulated in a virtual environment. Aspects of the dynamic pricing device 102 may leverage known, related art, or later developed off-the-shelf software. Other embodiments may comprise the dynamic pricing device 102 being integrated or in communication with a mobile switching center, network gateway system, Internet access node, application server, IMS core, service node, or some other communication systems, including any combination thereof. In some embodiments, the dynamic pricing device 102 may be integrated with or implemented as a wearable device including, but not limited to, a fashion accessory (e.g., a wrist band, a ring, etc.), a utility device (a hand-held baton, a pen, an umbrella, a watch, etc.), a body clothing, or any combination thereof.

In some embodiments, the dynamic pricing device 102 may automatically retrieve interactions between the request device 104 and the service devices 106 over the network 108 via respective input devices (e.g., keyboard, touchscreen, etc.) and respective sensors (e.g., touch sensors, location sensors, gyroscopes, imaging sensors, motion sensors, etc.). These interactions may include queries, instructions, conversations, or data from the request device 104 and the service devices 106 to the dynamic pricing device 102, or vice versa. The dynamic pricing device 102 may include a variety of known, related art, or later developed interface(s) 203, including software interfaces (e.g., an application programming interface, a graphical user interface, etc.); hardware interfaces (e.g., cable connectors, the keyboard, a touchscreen, a card reader, a barcode reader, a biometric scanner, an interactive display screen, etc.); or both.

The dynamic pricing device 102 may further include a system memory 204 for storing at least one of (1) files and related audio, video, or textual data including metadata, for example, data size, data format, creation date, associated tags or labels, related documents, messages, etc.; (2) profiles of users, e.g., customers, requesting a service, service operator profiles (e.g., cab driver profiles, etc.); (3) requests received over a predetermined period of time; (4) a dedicated or shared digital wallet for users such as customers; (5) optimal commission rate for the service operators for different request types; (6) combined plans or prepaid plans with discounts instrumented through the digital wallet for the customers; (7) a log of profiles of network devices and associated communications including instructions, queries, conversations, data, and related metadata; and (8) predefined mathematical models or equations and related predetermined labels. In some embodiments, the dynamic pricing device 102 may perform one or more operations, but not limited to, reading, writing, indexing, labeling, updating, and modifying the data, and may communicate with various networked computing devices.

The system memory 204 may comprise any computer-readable medium known in the art, related art, or developed later including, for example, a processor or multiple processors operatively connected together, volatile memory (e.g., RAM), non-volatile memory (e.g., flash memory, etc.), disk drive, etc., or any combination thereof. The system memory 204 may include one or more databases such as a database 206, which may be sub-divided into further databases for storing electronic files and data. The system memory 204 may have one of many database schemas known in the art, related art, or developed later for storing data from the request device 104 and the service device via the dynamic pricing device 102. For example, the database 206 may have a relational database schema involving a primary key attribute and one or more secondary attributes.

In one embodiment, the system memory 204 may include various modules such as an input module 208, a pricing module 210, a matching module 214 and an output module 212. The input module 208 may be configured to receive a service request from a request device 104 for a predetermined service such as a cab service. The service request may be represented by a variety of parameters based on the service conditions (e.g., business field of service operation, service subscription type, geographical region of service operation, etc.). For example in case of cab services, a service request may be represented by parameters, such as, request source, request destination, and request time. Each of these parameters may influence operational costs for delivering cab services, thereby leading to service or rejection of requests by the service operators such as cab drivers. These parameters also define a type for the service request based on the underlying values. For example, a first set of service requests having the request source as A, the request destination as B, and the request time between 6 am and 9 am may be determined as a first request type. Similarly, a second set of service requests having the request source as C, the request destination as B, and the request time between 9 am and 12 pm may be determined as a second request type. In some embodiments, the request time may be categorized within a predefined time interval, which may correspond to, for example, a three-hour interval in a day, such as (6 am to 8:59 am), (9 am to 11:59 am), (12 pm to 2:59 pm), and so on.

In one embodiment, the input module 208 may be operatively associated, installed, or integrated with a global positioning system (GPS) module (not shown), which may automatically detect and associate location data (hereinafter referred to as customer GPS data) with the request device 104 to determine the request source. The GPS data may at least include latitude and longitude data; however, other data including, but not limited to, locality name and city name may be provided by the GPS data. Additionally, the input module 208 may be configured to determine the number of cabs available within a predefined service vicinity of the request source based on GPS data provided by the GPS module (not shown) of the respective cabs. In some embodiments, the location data may be provided by a user, for example, a customer or a cab driver. The input module 208 may provide the received service request to the pricing module 210. The input module 208 may also retrieve cab driver profile data based on the received cab GPS data and send both the retrieved cab driver profile data and the cab GPS data to the pricing module 210.

The pricing module 210 may include a discount computation module 216, and a commission rate computation (CRC) module 218. The input module 208 may feed the received service request to the CRC module 218 and the matching module 214, which may additionally receive the cab driver profile data and the GPS data of cabs within the service vicinity from the input module 208. The CRC module 218 may be configured to estimate commission rates for service operators such as cab drivers based on the received service requests, which may be collated for a predetermined time interval (e.g., 30 seconds, 60 seconds, etc.), hereinafter referred to as time epoch, to create batched requests. Each batched request may be processed together for each time epoch to maximize the revenue of the service provider, as represented in Equation 1.

Maximum Revenue=maximize ΣᵢA(cᵢ)·cᵢ·rᵢ (1)

In Equation 1, A(cᵢ) refers to an indicator function that denotes whether or not the service request i has been accepted by an available cab driver to which the request i has been matched for an offered commission rate cᵢ and sᵢ refers to ride fare or service charge that a customer pays to the service operator such as a cab driver. The estimated commission rate cᵢ may range from a predefined minimum commission rate to a predefined maximum commission rate, as represented in Equation 2.

cᵢ∈[c,c̅] (2)

In Equation 2, cᵢ for each service request i, c∈[0, 1] refers to the minimum commission rate, c̅∈[0, 1] refers to the maximum commission rate, and i refers to a service request from a set of service requests I received within a predetermined time epoch (e.g., 60 seconds). Each of the minimum commission rate and the maximum commission rate may be preset based on the service conditions.

In order to estimate the optimal commission rate cᵢ* that maximizes the revenue as represented in Equation 1, the CRC module 218 may be configured to operate in a variety of settings such as a first setting, a second setting, and a third setting. Each setting may be based on a predetermined condition, e.g., all the service operators, such as the cab drivers are homogeneous, i.e., the cab drivers accept estimated commission rates that are relatively less than the optimal commission rate when the particular cab is within the predefined service vicinity or radius of the request source. Therefore, A(cᵢ) does not depend on the cab driver requested to serve the request i, when the vehicle is within a predefined service vicinity, rather depends only on the estimated commission rate cᵢ′ based on Equations 1 and 2. The optimal commission rate cᵢ* may depend on the estimated commission rate and associated revenue of a request.

### First Setting

In the first setting, the CRC module 218 may be preset with a condition that the service operators such as the cab drivers have consistent deterministic or static behavior for the different commission rates based on the request type and availability of cabs/cab drivers. In other words, for a particular type of request i, all drivers within the predefined service vicinity will always accept the request i at a predefined commission rate cᵢ or lower. Moreover, the preset condition may additionally include that, for any type of request i, all available cab drivers will always accept a commission rate less than the predefined minimum commission rate c and always reject a request at a commission rate, which is greater than the predefined maximum commission rate c̅. Therefore as the estimated commission rate cᵢ′ for the cab driver decreases below a predefined commission rate such as cᵢ, the corresponding revenue of the service provider increases, as represented in Equation 3.

If cᵢ>cᵢ′ then A(cᵢ)≦A(cᵢ′) (3)

The CRC module 218 may be configured to implement a variety of algorithms known in the art, related art, or developed later such as polynomial time algorithms to determine the optimal commission rate cᵢ* for each request within a particular time epoch. In one embodiment, the CRC module 218 may retrieve and process a weighted directed bipartite graph, as represented in Equation 4, built by the matching module 214 for each time epoch t using the Hungarian algorithm.

G^{t}=(X^{t}∪Y^{t},ε^{t}) (4)

In Equation 4, G^{t} refers to a weighted directed bipartite graph having one partition that includes vertices X^{t} representing the requests received at the time epoch t, another partition having vertices Y^{t} representing available cab drivers, and an edge e∈ε^{t} connecting a vertex x∈X^{t} and a vertex y∈Y^{t}, which exists if and only if a corresponding cab driver is available within a predefined vicinity or radius of the origin of the request x. The edges are directed from requests to the cab drivers. Similar edges may be defined for each request in the time epoch.

In order to determine the optimal commission rate cᵢ* actually maximizes the revenue represented in Equation 1, the CRC module 218 may estimate a random value of the commission rate cᵢ′ within the predetermined range as shown in Equation 2. Alternatively, such random value of the commission rate cᵢ′ may be inputted or preset by a user such as a service provider. The CRC module 218 may match the estimated commission rate cᵢ′ with the available drivers from the set of drivers represented by Y^{t}. For such matching, the CRC module 218 may be preset with a condition that if the distance between a cab driver and the request source is less than a predefined distance, then there is a probability p with which the cab driver y may be available to serve a request x. Such matching may be represented on the weighted directed bipartite graph as an edge connecting a request represented by a vertex x with all the available drivers represented by the set of vertices Y^{t}.

Since for each request type in a particular time epoch, the requests (e.g., long distance requests, etc.) that provide highest estimated revenue may get prioritized to be matched, the requests with relatively lower revenue may not get served or remain underserved. In order to ensure that optimal commission rates are determined for such requests that yield relatively lower revenue, the CRC module 218 may be configured to augment the estimated revenue of requests, which have not yet converged to an optimal commission rate, with a multiplicative term or weight represented in Equation 5.

$$w ( e ) = {a}_{i} \cdot {c}_{i}^{*} \cdot {r}_{i} + ( 1 - {a}_{i} ) \cdot ( \frac{log {C}_{r}}{{n}_{i} + 1} ) {c}_{i}^{′} \cdot {r}_{i} \qquad ( 5 )$$

where:

e=edge in the weighted directed bipartite graph G^{t}

w(e)=weight or multiplicative term

cᵢ*=optimal commission rate for the request i

rᵢ=ride fare or service charge for the request i

nᵢ=number of times the request i is served

cᵢ′=estimated commission rate for the request i

$${C}_{r} = ⌈ \frac{\overline{c} - \underline{c}}{ɛ} ⌉$$

and

$${a}_{i} = \{ \begin{matrix}1 , & if {c}_{i}^{*} is reached \\ 0 , & otherwise\end{matrix}$$

In other words, the edge such as the edge ‘e’ that connects the vertex x representing a request i and the vertex y representing a cab driver may be attached with the multiplicative term. The weight or the multiplicative term may depend on the number of times the above mentioned matching is being implemented for a request type, and assists to prioritize computing the commission rates based on the requests that has been least served. Greater the weight, higher is the priority of the request. Such assignment of the weights to the edges may be performed for the batch of requests received and the available cab drivers in every time epoch.

The CRC module 218 provides the estimated commission rate to the matching module 214, which may provide the estimated commission rate to all the available cab drivers within the service vicinity via the interface(s) 203. Since, in the first setting, each of the available cab drivers are considered to have a common deterministic behavior, the CRC module 218 can delay further processes until a response to the provided commission rate is received from any of the available cab drivers via the matching module 214. Based on the cab driver response received from the matching module 214, the CRC module 218 may be configured to perform a binary search over a discrete set of commission rates bounded by the minimum commission rate c and the maximum commission rate c̅ for determining the optimal commission rate based on the estimated commission rate.

Starting from the minimum commission rate c, the CRC module 218 may update the commission rate by a sizing parameter E in order to provide a discrete set of acceptable commission rates {c, c+∈, . . . , c̅}. The value of the sizing parameter E may be determined to be a small quantity (e.g., 0.1, 0.15, 0.2, etc.) based on the desired level of granularity for determining the optimal commission rate cᵢ*.

Over such discrete set of acceptable commission rates, the CRC module 218 may perform a binary search until the difference between the previously estimated commission rate and updated commission rate falls below the sizing parameter E. Such updated commission rate for which the difference falls below the sizing parameter may be determined as the optimal commission rate by the CRC module 218 and stored in the database 206 for the received type of service request. Maximum number of iterations that may be required to be performed the binary search by the CRC module 218 for determining the optimal commission rate may not exceed ┌log Cᵣ┐, where Cᵣ is defined in Equation 5.

During the binary search, the CRC module 218 may update the predefined minimum commission rate as shown in Equation 6 when the estimated commission rate is accepted by the cab driver, or update the predefined maximum commission rate as shown in Equation 7 when the cab driver has rejected the estimated commission rate.

$$\begin{matrix}\underline{c} = [ \frac{\underline{c} + \overline{c}}{2} ] & ( 6 ) \\ \overline{c} = [ \frac{\underline{c} + \overline{c}}{2} ] & ( 7 )\end{matrix}$$

Based on the updated predefined minimum commission rate or the updated predefined maximum commission rate, the optimal commission rate cᵢ* may be determined. Accordingly, the CRC module 218 may use such determined commission rate as a starting point to learn the optimal commission rate cᵢ* that maximizes the revenue through the accepted commission rates fed back to the CRC module 218 from the matching module 214 for over a set of requests in received in different time epochs. Such operation may be repeated for multiple sets of requests at various time epochs in real time to train the CRC module 218 with optimal or near-to-optimal commission rates for different request types.

In some embodiments, the CRC module 218 may additionally include driver's profile to estimate the commission rates but the convergence to obtain the optimal commission rate may become slower, thereby relatively increasing the computation time. This is because the current commission rate depends on a tuple (i; j) where i refers to the request type and j refers to the driver type, and can be updated only when the particular tuple is matched.

### Second Setting

In the second setting, the CRC module 218 may be preset with various conditions based on characteristics of the behaviors of service operators such as the cab drivers. One of the characteristics may refer to the stochasticity being introduced in the behaviors of cab drivers. In other words, the cab drivers may have a steady probability of acceptance p(cᵢ) associated with each discrete commission rate (i.e., cᵢ∈{c, . . . , c̅} for every type of request i), which may depend on the request type and availability of cab drivers, due to variable parameters. Examples of such variable parameters may include, but are not limited to, anomalous traffic conditions, road blocks due to maintenance, and driver's personal preference at the time of arrival of the request, etc. Such variable parameters may introduce some uncertainty in the acceptance of commission rates by the available cab drivers.

Another characteristic may refer to the drivers having a consistent and rational behavior, which may signify that the acceptance probability associated with a particular commission rate cannot decrease as the commission rate charged by a service provider is lowered. Yet another characteristic may refer to the driver behaving in steady state, which may signify that the probabilities associated with the commission rates may be stationary, i.e., the probabilities associated with the commission rates do not change over time. Therefore as the estimated commission rate cᵢ′ for the cab driver decreases below the predefined commission rate cᵢ, the probability of accepting the estimated commission rate cᵢ′ increases, as represented in Equation 8.

If cᵢ>cᵢ′ then p(cᵢ)≦p(cᵢ′) (8)

Therefore, the CRC module 218 may be configured to determine the expected optimal commission rate cᵢ* that must be charged from the cab drivers for a service request in the case where the overall revenue earned by the service providers is maximized, as represented in Equation 9.

cᵢ*=arg max_{c}_{ᵢ}_{∈┌c,c̅┐}p(cᵢ)·cᵢ·rᵢ (9)

The CRC module 218 may determine the optimal commission rate cᵢ* in a manner similar to the first setting as discussed above; however, each estimated commission rate can be utilized multiple times for a given type of request in order to estimate the associate probability using that particular commission rate with reasonable confidence. Hence, the number of iterations required to converge to the optimal commission rate may increase. The maximum number of iterations required for trials of each commission rate may depend on the maximum error ∈ and the minimum confidence with which the CRC module 218 estimates the commission rates. The maximum error ∈ may be tolerated during estimation of the probabilities and the minimum confidence may be represented as (1−δ).

The CRC module 218 may estimate the probability of acceptance of acceptance of a commission rate for a request with some confidence using a variety of methods known in the art, related art, or developed later. Once such probability of acceptance of a commission rate for a request is estimated, the CRC module 218 may update this estimated probability according to the observed probability by using a binary search across different commission rates.

If the observed probability for a commission rate is P percent (e.g., P=80) or higher, the CRC module 218 may search in the upper half of the discrete set of commission rates, else in the lower half of the discrete set of commission rates. Such segmented searching may be implemented since the CRC module 218 may be preset with a condition that the behavior of the drivers may remain unchanged with respect to the estimated commission rates being less than the predefined commission rate as represented in Equation 8.

The maximum number of trials of each commission rate for a request nₚ during the search may be equivalent to a value as shown in equation 10 based on the Chernoff bound.

$${n}_{p} = ⌈ \frac{ln 2 / δ}{2 {ɛ}^{2}} ⌉ \qquad ( 10 )$$

The CRC module 218 may determine a ratio of the number of acceptances of each estimated commission rate by a cab driver for each request and the total number of trials of each estimated commission rate (using the binary search in the discrete set of commission rates). So, when the maximum number of trials of each estimated commission rate has already been performed, the CRC module 218 may update the predefined maximum commission rate as shown in Equation 7 when the ratio is less than the observed probability, or may otherwise update the predefined minimum commission rate as shown in Equation 6.

In some embodiments, the CRC module 218 may additionally include a cab driver's profile to estimate the commission rates. However, using a cab driver's profile to obtain the optimal commission rate may cause the algorithmic convergence time to slow. This is because the commission rate may depend on the tuple (i; j) where i refers to the request type and j refers to the driver type, and each update can be made only when the particular tuple is matched nₚ number of times, as represented in equation 10.

### Third Setting

In contrast to the second setting, the probabilities associated with the commission rates may change over time in a dynamic environment, for example, due to changing urban environment, such as new shopping malls being constructed, changes in routes of public transportation, etc. In the third setting, the CRC module 218 may consider that the driver behaviors are not steady or stationary, and the probability of acceptance for different commission rates keeps changing over time. Accordingly, the CRC module 218 may be configured to simultaneously use the concepts of the first setting and second setting to adaptively choose a commission rate for each service request with the goal of maximizing the revenue. The CRC module 218 may observe the cab driver behavior for a particular commission rate for a predefined time interval, and determine the change in trend, if any of the associated probability. Accordingly, the CRC module 218 may update the probability in a linear manner based on predefined step size so that the probability may be estimated gradually. In other words, the CRC module 218 may observe the driver behavior corresponding to a particular commission rate for a predefined time, and if the observed estimated probability of acceptance for the current commission rate is above a predefined upper threshold Pu (e.g., 90%), the CRC module 218 may increase the commission rate by the sizing parameter E; or if the observed estimated probability falls below a lower predefined threshold PI (e.g., 70%), the CRC module 218 may decrease the commission rate by the sizing parameter ∈ in order to perform the binary search in the discrete set of commission rates. Otherwise, the CRC module 218 may follow usual method to update the commission rate as discussed above for the first setting and the second setting.

The CRC module 218 may be configured to implement each of the first setting, second setting, and the third setting either independently or simultaneously based on a user request or a predefined feature. The CRC module 218 may store the determined optimal commission rate for each request type in the database 206.

The discount computation module 216 may either retrieve the determined optimal commission rate from the database 206 or receive the determined optimal commission rate from the CRC module 218. In one embodiment, the discount determination module 216 may be configured to determine discounts for customers based on the determined optimal commission rate for each request type. In some embodiments, the discount computation module 216 may be configured to provide a prepaid combination plan with discounts based on a digital wallet. For example, a plan that has been prepaid through the digital wallet may be discounted for different types of travel such as point-to-point, airport pick-up or drop, hourly rental, outstation travel, and so on. Different types of discounts may be provided by the discount computation module 216. In one example, x % discount may be provided if trips worth of R amount are made in T duration of days or months. In another example, y % discount may be provided on first k trips of a particular type (e.g., to a fixed destination, point-to-point travels, etc.).

Such discounts may be determined by the service provider and predefined in the discount computation module 216 based on trends in, or percentage of, acceptable commission rates determined for different types of requests. In some embodiments, the types of requests may be limited in the prepaid plans, i.e., granularity of origin, destination and time of request may be coarse. For example, origin and destination locations may be geographical zones and the time of request may be time periods, such as peak or non-peak hours.

The output module 212 may be configured to receive combination plans or prepaid plans with discounts from the discount computation module 216 and the cab drivers that match with a service request based on the optimal commission rate that maximizes the revenue or profits of the service provider as computed by the CRC module 218. The output module 212 may send the details, such as those mentioned above, of the matched cab driver to the request device 104 or any other networked device over the network 108. The output module 212 may also provide the prepaid plans or combination plans with discounts to a user on the request device 104 or any other networked device over a communication platform, e.g., a website, in a variety of visualizations or data representation formats, or both, known in the art, related art, or developed later.

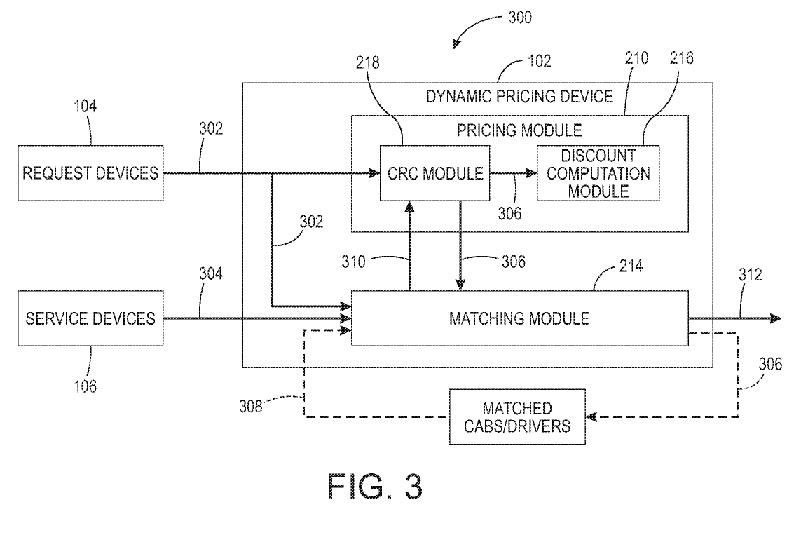

FIG. 3 is a schematic that illustrates an exemplary operation of the dynamic pricing device 102 of FIG. 1, according to an embodiment of the present disclosure. In one embodiment, a customer may send a service request 302 such as for cab services to the dynamic pricing device 102, which is in communication with one or more service operators such as cab drivers. The request 302 may be characterized by a variety of parameters such as request source, request destination, and request time, which may be provided by the customer through a user device such as the request device 104. In some embodiments, the dynamic pricing device 102 may automatically determine one or more of these parameters upon receiving the request 302. For example, the dynamic pricing device 102 may determine the request source based on the GPS data of the request device 104. In another example, the dynamic pricing device 102 may identify the request 302 time based on predefined time intervals, for example, (6:00 am to 8:59 am), (9:00 am to 11:59 am), and so on. The request 302 may be fed to the pricing module 210 and the matching module 214 via the input module 208 of the dynamic pricing device 102.

The matching module 214 may receive the request 302 from the customer and determine the service operators such as cab drivers that are vacant and are available within the service vicinity of the request source based on data 304 (e.g., GPS data, cab driver profile data, etc.) received from the service devices 106. Additionally, the matching module 214 may interact with the CRC module 218 of the pricing module 210 to receive a commission rate 306 for the request 302 received from the customer.

The matching module 214 may send the received commission rate 306 to at least one service operator such as a cab driver from the set of available cab drivers. The cab driver may send out a response to the matching module 214 based on the obtained commission rate 306.

In one example, when the service operator such as a cab driver from the set of available cab drivers sends an acceptance response 308 based on the obtained commission rate, the matching module 214 may match such cab driver with the request and outputs the acceptance details 312 of the cab driver. Such acceptance details 312 may include the accepted source, accepted destination, accepted time, and accepted commission rate 310 for the request 302 that may be stored in the database 206. In some embodiments, the acceptance details 312 may also include the cab driver details such as cab driver name, cab number, and so on, which may be sent to the request device 104 over the network 108. In other embodiments, the cab driver details may be sent to the request device 104 by the service device of the cab driver who has accepted the request for the commission rate provided by the CRC module 218. The matching module 214 may further communicate the accepted commission rate 310 to the CRC module 218 as a feedback.

On the other hand, the CRC module 218 of the pricing module 210 may receive the service request 302 from the customer via the input module 208 over the network 108. For the request, the CRC module 218 may estimate a commission rate 306 for the set of available drivers determined by the matching module 214. The estimated commission rate 306 may be sent to the matching module 214 for a response 308 from the available cab drivers. Based on the response 308, the CRC module 218 updates the estimated commission rate 306 to compute the optimal commission rate for the drivers over multiple requests of same type based on the accepted commission rate 310 received as feedback from the matching module 214. The optimal commission rate optimizes the revenue or profits of the service provider based on the first setting, the second setting, or the third setting implemented by the CRC module 218. Each of the estimated commission rates 306 may be sent to the discount computation module 216, which may determine prepaid plans or combination plans with discounts instrumented through a digital wallet topped-up with virtual money by the customer. The determined prepaid plans or combination plans with discounts may be accessed by the customer using the request device 104 or via a communication platform such as a website using a dedicated login credentials (e.g., a username and password, biometric scan, etc.). Such prepaid plans or combination plans with discounts may be provided to the customer in any of a variety of visualizations and data representation formats known in the art, related art, or developed later.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

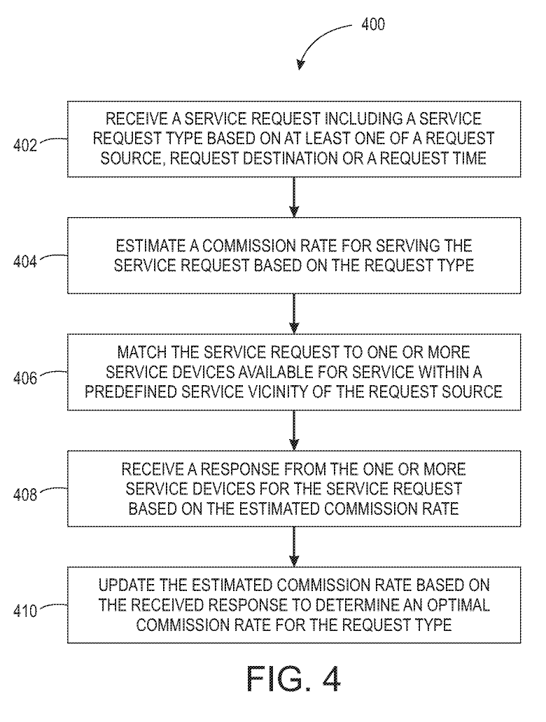

FIG. 4 is a flowchart 400 illustrating exemplary method steps for determining an optimal commission rate, according to an embodiment of the present disclosure. The method includes receiving a service request (step 402); the service request includes request type based on at least one of a request source, request destination or a request time. In an embodiment, the service request can be received by the commission rate computation (CRC) module. Based on the request type, a commission rate is determined for serving the request (step 404). The commission rate can be determined by the CRC module. Thereafter at 406, matching is performed to match the service request to one or more service devices available for service within a predefined service vicinity of the request source, wherein the one or more service devices receive the estimated commission rate. The step of matching is performed by the matching module while in communication with the CRC module. Then, at 408, the response is received from the one or more service devices for the service request based on the estimated commission rate, by the matching module. At 410, the step of updating the estimated commission rate based on the received response to determine an optimal commission rate for the request type is performed, by the CRC module, the optimal commission rate maximizes revenue earned from the service request. Other than the above steps, the method includes categorizing the request time within a predefined time interval. The method also includes the steps of collating the service request with another service request having the same request type within predetermined time duration. Additionally, the method includes providing discounts instrumented through a digital wallet for the service request based on the request type.

The method steps as recited above are performed by different modules such as CRC module, matching module, or the like. However, it is understood that the method can be performed by any equivalent module or a system having a number of modules.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the subject matter as encompassed by the following claims.

What is claimed is:

1. A dynamic pricing system, for cab services, for determining an optimal commission rate based on a service request being served, the dynamic pricing system comprising:
at least one service device that can communicate with a request device, wherein the at least one service device provides a response for a service request; and
a dynamic pricing device interfacing with the at least one service device, wherein the dynamic pricing device determines an optimal commission rate corresponding to a request type for the at least one service device, wherein the optimal commission rate maximizes revenue from the service request.

2. The dynamic pricing system of claim 1, wherein the request type is based on at least one of a request source, a request destination, or a request time, wherein the request source may be determined by the dynamic pricing device based on GPS data contained in data received for a service request.

3. The dynamic pricing system of claim 1, wherein the request time is categorized within a predefined time interval.

4. The dynamic pricing system of claim 1, wherein the service request is collated with another service request having the same request type within a predetermined time duration.

5. The dynamic pricing system of claim 1, wherein the optimal commission rate is determined based on an estimated commission rate offered to the plurality of service devices being updated based on the response received for the service request.

6. The dynamic pricing system of claim 1, further configured to provide discounts instrumented through a digital wallet for the service request based on the request type.

7. The dynamic pricing system of claim 1, wherein the plurality of service devices are available for service within a predetermined service vicinity of the request source.

8. A dynamic pricing device, for cab services, for determining an optimal commission rate based on a service request being served, the dynamic pricing device comprising:
a commission rate computation (CRC) module configured to:
receive a service request that has a request type based on at least one of a request source, request destination, or a request time; and
estimate a commission rate for serving the service request based on the request type;
a matching module in communication with the CRC module, wherein the matching module is configured to:
match the service request to one or more service devices available for service within a predefined service vicinity of the request source, wherein the one or more service devices receive the estimated commission rate; and
receive a response from the one or more service devices for the service request based on the estimated commission rate; and
wherein the CRC module is configured to update the estimated commission rate based on the received response to determine an optimal commission rate for the request type, wherein the optimal commission rate maximizes revenue earned from the service request.

9. The dynamic pricing device of claim 8, wherein the CRC module is further configured to categorize the request time within a predefined time interval.

10. The dynamic pricing device of claim 8, wherein the CRC module is further configured to collate the service request with another service request having the same request type within a predetermined time duration.

11. The dynamic pricing device of claim 8, further comprises a discount computation module in communication with the CRC module, wherein the discount computation module is configured to provide discounts instrumented through a digital wallet for the service request based on the request type.

12. A computer-implemented method for determining an optimal commission rate based on a service request being served, the method comprising:
receiving, by a commission rate computation (CRC) module, a service request that has a request type based on at least one of a request source, request destination, or a request time;
estimating, by the CRC module, a commission rate for serving the service request based on the request type;
matching, by a matching module in communication with the CRC module, the service request to one or more service devices available for service within a predefined service vicinity of the request source, wherein the one or more service devices receive the estimated commission rate;
receiving, by the matching module, a response from the one or more service devices for the service request based on the estimated commission rate; and
updating, by the CRC module, the estimated commission rate based on the received response to determine an optimal commission rate for the request type, wherein the optimal commission rate maximizes revenue earned from the service request.

13. The method of claim 12, wherein the step of receiving the service request further comprises categorizing the request time within a predefined time interval.

14. The method of claim 12, wherein the step of receiving the service request further comprises collating the service request with another service request having the same request type within a predetermined time duration.

15. The method of claim 12, further comprises providing discounts instrumented through a digital wallet by a discount computation module for the service request based on the request type.

16. A non-transitory computer-readable medium comprising computer-executable instructions for determining an optimal commission rate based on a service request being served, the non-transitory computer-readable medium comprising instructions for:
receiving, by a commission rate computation (CRC) module, a service request that has a request type based on at least one of a request source, request destination, or a request time;
estimating, by the CRC module, a commission rate for serving the service request based on the request type;
matching, by a matching module in communication with the CRC module, the service request to one or more service devices available for service within a predefined service vicinity of the request source, wherein the one or more service devices receive the estimated commission rate;
receiving, by the matching module, a response from the one or more service devices for the service request based on the estimated commission rate; and
updating, by the CRC module, the estimated commission rate based on the received response to determine an optimal commission rate for the request type, wherein the optimal commission rate maximizes the revenue earned based on the service request being served.

17. The non-transitory computer-readable medium of claim 16, wherein the step of receiving the service request further comprises categorizing the request time within a predefined time interval.

18. The non-transitory computer-readable medium of claim 16, wherein the step of receiving the service request further comprises collating the service request with another service request having the same request type within a predetermined time duration.

19. The non-transitory computer-readable medium of claim 16, further comprises providing discounts instrumented through a digital wallet by a discount computation module for the service request based on the request type.
